(19) United States
(12) Patent Application Publication
(10) Pub. No.: US 2006/0039778 A1
(43) Pub. Date: Feb. 23, 2006

(54) Stamped rivet

(75) Inventor: Erich Palm, Au (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS Intec Holding AG, Heerbrugg (CH)

(21) Appl. No.: 10/536,947

(22) PCT Filed: Dec. 15, 2003
(86) PCT No.: PCT/EP03/14245

§ 371 Date: May 31, 2005

(30) Foreign Application Priority Data
Dec. 18, 2002 (DE) 102 59 370.1

(51) Int. Cl. F16B 15/08

(52) U.S. Cl. 411/455

(57) ABSTRACT

A stamped rivet (10) for the connection of metal sheets (12, 14) to each other is provided, and includes a shaft (16) with several circumferential ribs (18) located one above another on the shaft (16), a shaft end (20) for pressing through the sheets (12, 14) for connection to each other, and a head (26). An adjacent region (30) to the shaft end (20) has no circumferential ribs and has a diameter smaller than an outside diameter (D) of the circumferential ribs. The stamped rivet (10) is easy to set as the setting device only has to be able to push the stamped rivet (10) through the sheets (12, 14) for connection. Sheet material is then forced by plastic deformation into the circumferential grooves (38) formed between the circumferential ribs (18).

### BACKGROUND

The invention relates to a stamped rivet for connecting metal sheets to one another, having a shaft with several circumferential ribs formed on the shaft one above the other and with a shaft end for pressing through the metal sheets to be connected to one another, with at least all circumferential ribs contacting the metal sheets having the same outside diameter, with the shaft being provided with a head opposite the shaft end, said head having a diameter greater than the outside diameter of the circumferential ribs, and with an adjacent area to the shaft end being free from circumferential ribs.

A stamped rivet is known from U.S. Pat. No. 4,978,270, provided without any head and serving for the connection of three metal sheets to one another. Its overall length is equivalent to the overall thickness of the metal sheets to be connected to one another so that it is flush with them in the installed state. This known rivet does not only represent a stamped rivet but simultaneously an embossed rivet as well. When such a stamped/embossed rivet has pressed through the metal sheets to be connected to one another under the formation of a punched hole, subsequently a groove is embossed around the two ends of the shaft in the respective neighboring sheet metal, causing material of the metal sheets to enter the circumferential grooves formed between two neighboring circumferential ribs each under plastic deformation, in order to form-fittingly connect the three metal sheets and the stamped rivet to one another. Due to the embossing process necessary, such a stamped/embossed rivet requires a rivet placing device designed appropriately elaborate. This device must be provided with a stamping tool and a corresponding male counterpart. Additionally, sufficient material can only be deformed into the circumferential grooves when the three metal sheets to be connected to one another are sufficiently thick. The known stamped/embossed rivet is obviously neither intended nor suitable for the connection of thin metal sheets to one another.

A stamped rivet of the type mentioned in the preamble of claim 1 is known from EP 1 054 169 A2. This known stamped rivet is a stamped/embossed rivet like the above-mentioned known stamped rivet. Due to the fact that it is provided with a frustum-shaped rivet head, the stamping process operates easier than with the above-mentioned known stamped rivet because a groove is to be embossed around the shaft end only. However, in this known stamped rivet, sufficient material can only be deformed into the circumferential grooves by way of embossing if the metal sheets to be connected are sufficiently thick.

### SUMMARY

The object of the invention is to provide a stamped rivet of the type mentioned at the outset, such that it allows a secure connection of metal sheets to be provided, particularly of thin metal sheets, in a simple manner.

This object is attained according to the invention with a stamped rivet of the type mentioned in the preamble of claim 1 in which the bottom of the head facing the shaft is planar, and that the neighboring area of the shaft end has a smaller diameter than the outside diameter of the circumferential ribs.

When the stamped rivet according to the invention is installed, at first the neighboring area of the shaft end enters the metal sheets to be connected to one another and pre-punches a punched hole, which has a smaller diameter than the outside diameter of the circumferential ribs. When subsequently the area of the shaft extending to the bottom of the head, in which the circumferential ribs are located, enters the punched hole, the hole is widened with sheet metal material entering the circumferential grooves formed between the circumferential ribs and, this way, finally the stamped rivet and the metal sheets are connected to one another in a form-fitting manner, when the head contacts with its bottom the metal sheets to be connected. Although the draw-out strength of such a rivet is smaller than in the above-described prior art, the placing of the stamped rivet according to the invention is considerably easier than in the known stamped rivets, because the stamped rivet according to the invention only needs to be pressed through the metal sheets to be connected and requires no embossing processes. The rivet placement tool can therefore be designed in an appropriately simple fashion and, in the simplest case, be a hammer operated manually. The stamped rivet itself is not being deformed during the placement process, similar to prior art.

The advantageous embodiments of the stamped rivet according to the invention form the objects of the sub claims.

When in an embodiment of the stamped rivet according to the invention the neighboring area has a cylindrical section, which transitions via a section that conically widens in the axial direction towards the head into an entry rib extending in the circumferential direction, with the outside diameter being smaller than the outside diameter of the circumferential ribs, a defined punched hole can be produced, which increasingly widens, with the help of the conical section, to the outside diameter of the entry rib and finally is widened by the circumferential ribs to their outside diameter.

When in another embodiment of the stamped rivet according to the invention the diameter of the cylindrical section is smaller than the smallest diameter of the shaft between the circumferential grooves formed between the ribs, it is ensured that finally the metal sheets are connected sufficiently tight in a form-fitting manner at the end.

When in another embodiment of the stamped rivet according to the invention the cylindrical section extends in the direction opposite to the head to the shaft end, the cylindrical section forms a stamp member, which can be provided with sharp edges at the circumference in order to facilitate and optimize the stamping process.

When in another embodiment of the stamped rivet according to the invention the cylindrical section in the direction opposite to the head converges into a conical point, the stamped rivet can be pressed with little force through the metal sheets to be connected to one another.

When in another embodiment of the stamped rivet according to the invention the circumferential ribs are triangular shaped in cross-section, the sheet metal material should most easily be able to enter under plastic deformation the circumferential grooves formed between the circumferential ribs.

When in another embodiment of the stamped rivet according to the invention the circumferential ribs in the cross-section are in a trapezoidal shape, the number of the circumferential ribs can be adjusted by selecting the width of the narrow side of the trapezoid in the available area depending on the purpose intended.

When in another embodiment of the invention the circumferential grooves formed between the circumferential ribs are V-shaped in the cross-section, the sheet metal material can easily penetrate under plastic deformation to the bottom of the circumferential grooves.

When in another embodiment of the stamped rivet according to the invention the bottom of the head converges into a cylindrical exit rib, which has the same outside diameter as the circumferential ribs, it is ensured that sheet metal material can penetrate under plastic deformation into the circumferential groove adjacent to the exit rib.

When in another embodiment of the stamped rivet according to the invention the circumferential ribs are formed in an area adjacent to the bottom of the head, with the axial length of said area being half as long as the total length of the shaft, the metal sheets to be connected to one another can vary in their thickness within a relatively wide range.

When in another embodiment of the stamped rivet according to the invention the overall length of the shaft is three to four times the total thickness of the metal sheets to be connected to one another, the shaft section not provided with circumferential ridges is also sufficiently long to securely pre-form a punched hole, which is brought into its final form by the circumferential ridges.

### BRIEF DESCRIPTION FO THE DRAWINGS

In the following, exemplary embodiments of the invention are explained in greater detail using the drawings. They show:

FIGS. 1a and 1b shows a side view and/or top view of a first exemplary embodiment of a stamped rivet according to the invention;

FIG. 2 shows the stamped rivet according to FIG. 1 in a posted state;

FIGS. 3a and 3b show a side view and/or top view of a second exemplary embodiment of the stamped rivet according to the invention;

FIGS. 4a and 4b show a side view and/or top view of a third exemplary embodiment of the stamped rivet according to the invention.

### DETAILED DESCRIPTION OF THE PREFERRED EMBODIMENTS

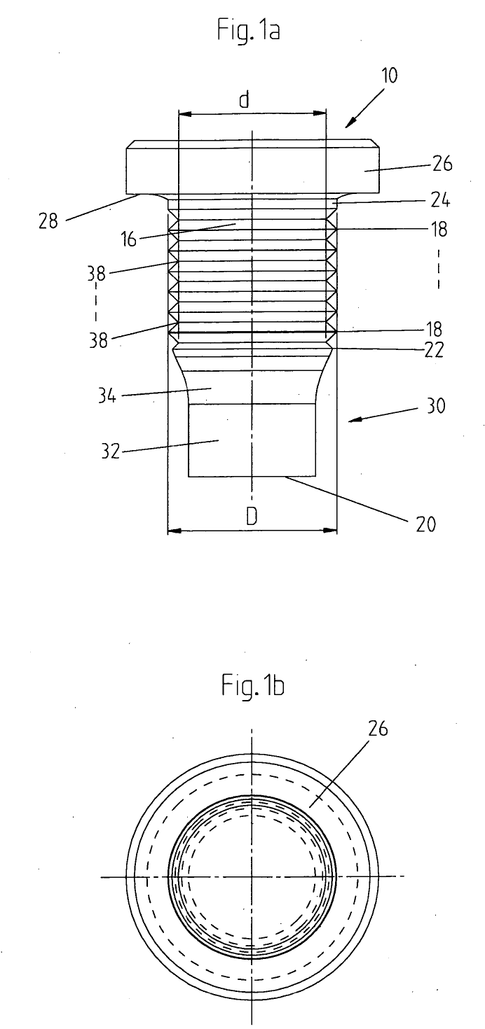

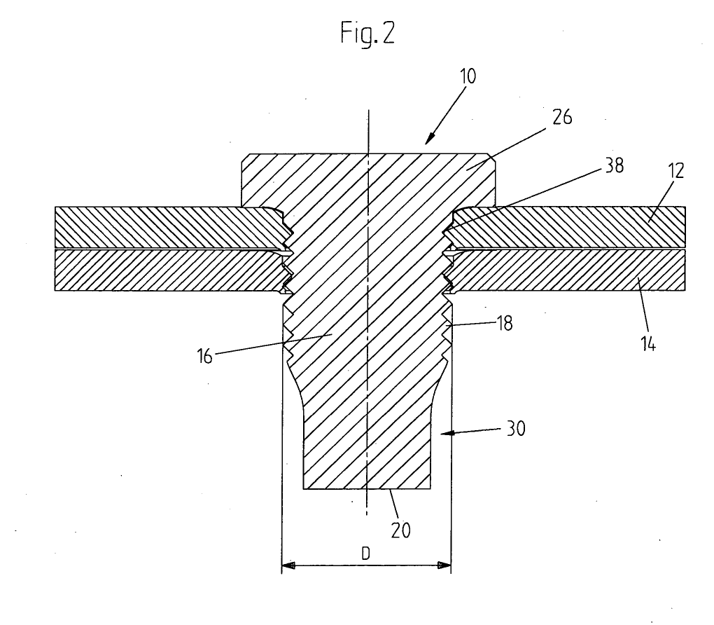

FIGS. 1a and 1b show a side view and/or top view of a first exemplary embodiment of a stamped rivet according to the invention, indicated as 10 in its entirety, which is shown in FIG. 2 in a longitudinal cross-section and in an installed state, in which it connects in a form-fitting manner two metal sheets 12, 14 to one another. The stamped rivet 10 has a shaft 16, several circumferential ribs 18 formed at the shaft 16 above one another, and a shaft end 20 for pressing through the metal sheets 12, 14 to be connected to one another. The two axially exterior circumferential ribs are embodied differently. They are an entry rib 22 and an exit rib 24, which will be explained in greater detail below. All circumferential ribs 18 engaging with the metal sheets including the exit rib 24 have the same outside diameter D.

Opposite to the shaft end 20, the stamped rivet 10 is provided with a head 26. The diameter of the head 26 exceeds the outside diameter D of the circumferential ribs 18. A bottom 28 of the head 26 facing the shaft 16 is provided with a planar shape so that a circular plane surface is provided for contacting the metal sheet 12. A neighboring area of the shaft end 20, indicated as 30 in its entirety, is free from circumferential ribs 18 and has a smaller diameter than the outside diameter D of the circumferential ribs 18. The neighboring area 30 is provided with a cylindrical section 32, which converges via a section 34, conically widening in the axial direction toward the head 26, into the entry rib 22 which extends in the circumferential direction, the entry rib having an outside diameter, which is smaller than the outside diameter D of the circumferential ribs 18, as easily discernible from FIGS. 1 and 2. The transfer from the cylindrical section 32 to the conical section 34 is rounded, as is discernible from the figures. The cylindrical section 32 has a diameter, which is smaller than the smallest diameter d of the shaft 16 between the circumferential grooves 18. The entry rib 22 is the rib, which first enters the punched hole, pre-punched by the cylindrical section 32, before subsequently the circumferential ribs 18, having a larger outside diameter D, enter the punched hole. Finally the exit rib 24 enters, being the last rib extending in the circumferential direction that penetrates the punched hole.

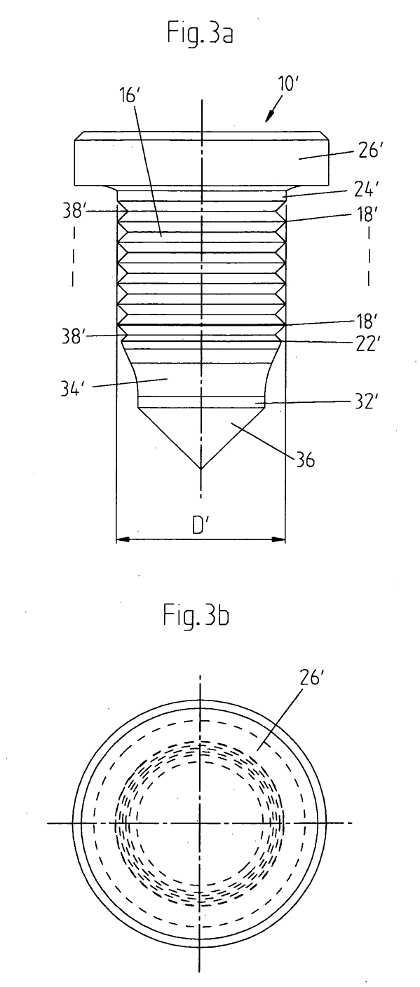

In the exemplary embodiment shown in FIG. 1, the cylindrical section 32 extends to the shaft end 20, opposite to the direction of the head 26. FIGS. 3a and 3b show a side view and/or top view of a second exemplary embodiment of a stamped rivet according to the invention, indicated as 10′ in its entirety, which differs from the stamped rivet 10 only in the fact that the cylindrical section 32′ has a shorter axial length than the cylindrical section 32 and that the cylindrical section 32′ converges into a conical point in the opposite direction of the head 26. The other parts of the second exemplary embodiment are identical to the first exemplary embodiment. In the stamped rivet 10 as well as in the stamped rivet 10′, the circumferential ribs 18 and/or 18′ have a triangular cross-section.

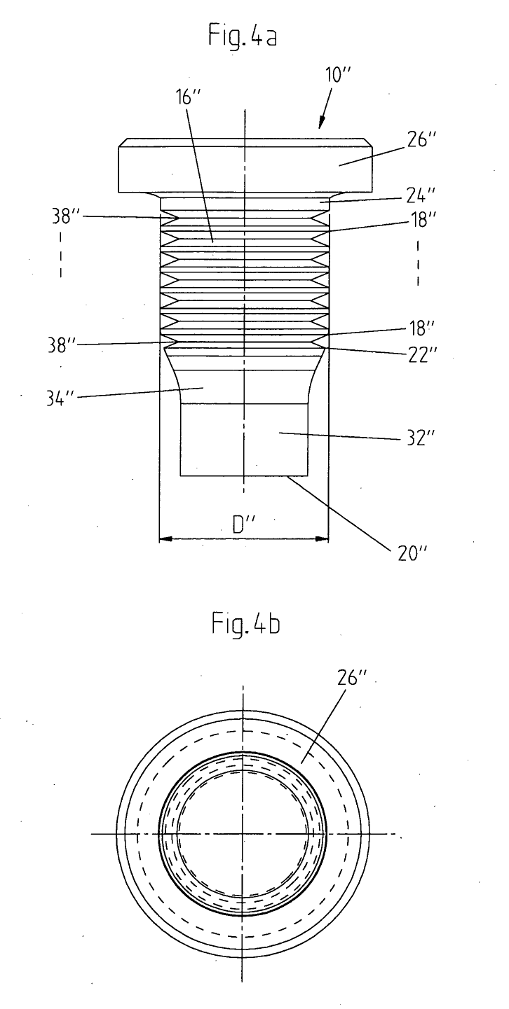

FIGS. 4a and 4b show a side view and/or top view of a third exemplary embodiment of a stamped rivet according to the invention, indicated as 10″ in its entirety, which is trapezoidal in its cross-section. The other parts of the exemplary embodiment according to FIG. 4 are identical to the exemplary embodiment according to FIGS. 1 and 2 and therefore need no further explanation.

In all three exemplary embodiments, the circumferential grooves 38, 38′, and 38″ formed between the circumferential ridges 18, 18′, and 18″ are V-shaped in their cross-section. Similarly, in all exemplary embodiments the head 26, 26′, and 26″ converges into the cylindrical exit rib 24, 24′ and/or 24″, which has the same outside diameter D, D′, and/or D″ as the circumferential ribs 18, 18′, and/or 18″. The circumferential ribs 18, 18′, 18″ are formed in an area 40, 40′ and/or 40″ adjacent to the bottom of the head 26, 26′, 26″, with its axial length being half as long as the overall length of the shaft 16, 16′ and/or 16″. The overall length of the shaft 16, 16′, 16″ amounts to three to four times the overall thickness of the metal sheets 12, 14 to be connected to one another.

1. A stamped rivet for connecting metal sheets to one another, comprising a shaft, several circumferential ribs provided one above the other on said shaft, and a shaft end for pressing through the metal sheets to be connected to one another, with at least all of the circumferential ribs engaging the metal sheets having an outside diameter that is the same, with the shaft, opposite to the shaft end, being provided with a head having a larger diameter than the outside diameter of the circumferential ribs, and with an adjacent area of the shaft end being free from circumferential ribs, wherein a bottom (28) of the head (26, 26′, 26″) facing the shaft (16, 16′, 16″) is planar and an adjacent area (30) to the shaft end (20) has a smaller diameter than an outside diameter (D, D′, D″) of the circumferential ribs (18, 18′, 18″):

2. A stamped rivet according to claim 1, wherein the adjacent area (30) has a cylindrical section (32, 32′, 32″) converging via a conically widening section (34, 34′, 34″) in a direction of the head (26, 26′, 26″) into an entry rib (22, 22′, 22″) which extends circumferentially and has an outside diameter smaller than the outside diameter (D, D′, D″) of the circumferential ribs (18, 18′, 18″).

3. A stamped rivet according to claim 2, wherein the diameter of the cylindrical section (32, 32′, 32″) is smaller than a smallest diameter (d) of the shaft (16, 16′, 16″) at circumferential grooves (38, 38′, 38″), which are formed between the ribs (18, 18′, 18″, 22, 22′, 22″, 24, 24′, 24″).

4. A stamped rivet according to claim 2, wherein the cylindrical section (32, 32″) extends in a direction opposite to the head (26, 26″) to the shaft end (20, 20″).

5. A stamped rivet according to claim 3, wherein the cylindrical section (32′) converges into a conical point (36) in the direction opposite to the head (26′)

6. A stamped rivet according to claim 3, wherein the circumferential ribs (18, 18′) have a triangular cross-section.

7. A stamped rivet according to claim 3, wherein the circumferential ribs (18″) have a trapezoidal cross-section.

8. A stamped rivet according to claim 3, wherein the circumferential grooves (38, 38′, 38″) formed between the circumferential ribs (18, 18′, 18″) have a V-shaped cross-section.

9. A stamped rivet according to claim 1, wherein the head (26, 26′, 26″) converges at a bottom (28) thereof into a cylindrical exit rib (24, 24′, 24″), which has an outside diameter (D) that is the same as the circumferential ribs (18, 18′, 18″).

10. A stamped rivet according to claim 1, wherein the circumferential ribs (18, 18′, 18″) are formed in an area adjacent to the bottom (28) of the head (26, 26′, 26″), which has an axial length half as long as an overall length of the shaft (16, 16′, 16″).

11. A stamped rivet according to claim 10, wherein the overall length of the shaft (16, 16′, 16″) exceeds an overall thickness of the metal sheets (12, 14) to be connected three to four fold.
